(19) United States
(12) Patent Application Publication
(10) Pub. No.: US 2008/0266130 A1
(43) Pub. Date: Oct. 30, 2008

(54) SYSTEM AND METHOD FOR AUTOMATED INTELLIGENT CUSTOMER ACQUISITION/COMMUNICATION

(76) Inventors: Charles C. Koo, Palo Alto, CA (US); Peter Lai, Palo Alto, CA (US); Xiaojun Yang, San Jose, CA (US)

Correspondence Address: THELEN REID BROWN RAYSMAN & STEINER LLP, P.O. BOX 640640, SAN JOSE, CA, 95164-0640, US

(21) Appl. No.: 11/941,967

(22) Filed: Nov. 19, 2007

Related U.S. Application Data
(60) Provisional application No. 60/914,799, filed on Apr. 30, 2007.

(51) Int. Cl. G08B 21/00

(52) U.S. Cl. 340/686.6

(57) ABSTRACT

A kiosk comprises: a motion sensor; electronics; and a speaker. The motion sensor senses a customer adjacent to the kiosk. The electronics, which are communicatively coupled to the sensor, determine if the customer has lingered by the kiosk for a period of time. The speaker, which is communicatively coupled to the electronics, emits an aural greeting if it is determined that the customer has not lingered.

### PRIORITY CLAIM

This application claims benefit of and hereby incorporates by reference U.S. provisional patent application Ser. No. 60/914,799, entitled “System and Method for Automated Intelligent In-Store Customer Acquisition/Communication,” filed on Apr. 30, 2007, by inventors Charles C. Koo et al.

### TECHNICAL FIELD

This invention relates generally to kiosks, and more particularly, but not exclusively, provides a system and method of attracting customers to a kiosk in a store or elsewhere.

### BACKGROUND

Nearly all kiosks and interactive systems installed in retail stores suffer from the problem of not being able to attract users to use them. Most kiosks and interactive systems rely on graphics printed on the external enclosure, or repetitive loops of computer graphics or videos displayed on their screens to attract users. However, the customer acquisition rate is typically low. Such low usage may be acceptable if the kiosk is used only to enhance shopper experience, but it is not acceptable if this kiosk is designed for advertising.

A conventional method to improve the customer acquisition rate is to attract attention via audio, such as a voice greeting. However, the very reason of attracting attention (in particular, voice greeting) is the same reason that alienates or even upsets the customer. The challenge of such a system is striking a subtle balance between (1) optimally attracting as many customers to use it (which will increase the frequency/volume of greetings) and (2) not to upset/annoy the customers or store employees who are standing near the kiosk. For example, one design may require the kiosk to continue broadcasting the greeting on a set frequency (e.g., every 15 seconds), while another to greet every time a motion is detected (e.g., when a motion detector is “ON”). The former will hit and miss, and surely annoy the customers who are standing nearby. The latter will continue to blast voice greetings if a customer is standing in the range of a motion detector even if not interested in the kiosk. Either process will guarantee the failure because of customer complaints. Worse yet, it will upset a store employee who may be present (e.g., on an aisle performing tasks such as restocking). It is frequently seen that the kiosk is “silenced” by a store employee either by being unplugged or shut down completely.

However, simply reducing the frequency/volume or skipping the greeting upon detecting motion will surely reduce the customer acquisition rate.

Accordingly, a new system and method are needed to increase customer acquisition without annoying store employees and/or lingering customers.

### SUMMARY

Embodiments of the invention provide a system and method to automate intelligent customer acquisition and communication via a kiosk using a unique combination of motion sensing, changing voice level, lighting, computer graphics and videos on screen, centering on an intelligent control method.

In an embodiment of the invention, a method comprises: sensing a customer adjacent to a kiosk using a motion sensor; determining if the customer has lingered by the kiosk for a period of time; and emitting a first aural greeting from the kiosk if it is determined that the customer has not lingered.

In an embodiment of the invention, the system (e.g., kiosk) comprises: a motion sensor; electronics; and a speaker. The motion sensor senses a customer adjacent to the kiosk. The electronics, which are communicatively coupled to the sensor, determine if the customer has lingered by the kiosk for a period of time. The speaker, which is communicatively coupled to the electronics, emits an aural greeting if it is determined that the customer has not lingered.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram of a store with a kiosk in accordance with an embodiment of the present invention;

FIG. 2 is a diagram illustrating floor area of a store in which the kiosk will detect motion;

FIG. 3 is a diagram illustrating a kiosk with a plurality of motion detectors;

FIG. 4 is a diagram illustrating a motion detector;

FIG. 5 is block diagram illustrating components of the kiosk according to an embodiment of the invention;

FIG. 6 is a block diagram illustrating a persistent memory of the kiosk; and

FIG. 7 is a flowchart illustrating a method of selectively generating aural greetings.

### DETAILED DESCRIPTION

The following description is provided to enable any person skilled in the art to make and use the invention and is provided in the context of a particular application. Various modifications to the embodiments are possible, and the generic principles defined herein may be applied to these and other embodiments and applications without departing from the spirit and scope of the invention. Thus, the invention is not intended to be limited to the embodiments and applications shown, but is to be accorded the widest scope consistent with the principles, features and teachings disclosed herein.

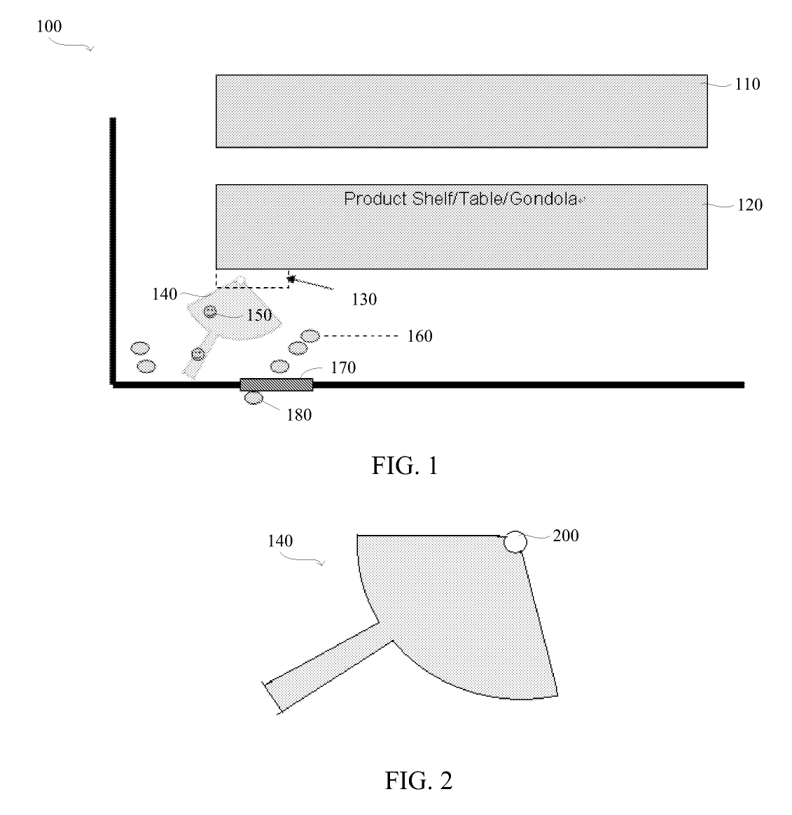

FIG. 1 is a diagram of a store 100 with a kiosk 130 in accordance with an embodiment of the present invention. The store 100 includes a plurality of product shelves, e.g., shelves 110, and 120, with the kiosk 130 positioned on or adjacent to a shelf, e.g., the shelf 120. The kiosk 130 detects motion along floor area 140. Inside the store 100 are also a plurality of customers 150 and 160. Customers 150 are within the floor area 140 while the customers 160 are outside the area 140 and are standing in line for a counter 170, with a pharmacist 180 behind the counter 170.

During operation of the store 100, the kiosk 130 uses motion sensing technology (e.g., electromagnetic radiation, such as infrared light, and/or sound, such as ultrasound, etc.) to detect customers 150 within the area 140. Once a customer is sensed, the kiosk 130 emits an aural greeting, such as, “Welcome!”, music, a chime, etc. As will be described further below, customers 160, which are outside the area 140, are not sensed and therefore the kiosk 130 does not issue an aural greeting for them. Further, the kiosk 130 does not always emit an aural greeting for the customers 150 within the area 140. Emission can be based on various factors, such as the location of the customer, whether the customer just passed the kiosk 130, and/or whether the customer has been shopping near the kiosk 130 for a period of time. These factors will be described further below.

The area 140 is shaped so as to not sense store employees, such as the pharmacist 180, that tend to stay within certain areas that would include an area sensed by a conventional kiosk. As such, the kiosk 130 does not sense the pharmacist 180 in his/her normal location, and therefore does not continuously issue aural greetings, which would lead to annoyance and possibly the deactivation of the kiosk 130 by the pharmacist 180.

FIG. 2 is a diagram illustrating the floor area 140 of a store 100 in which the kiosk 130 will detect motion. As such, the kiosk 130 will not sense customers outside of the area 140 and not emit an aural greeting accordingly.

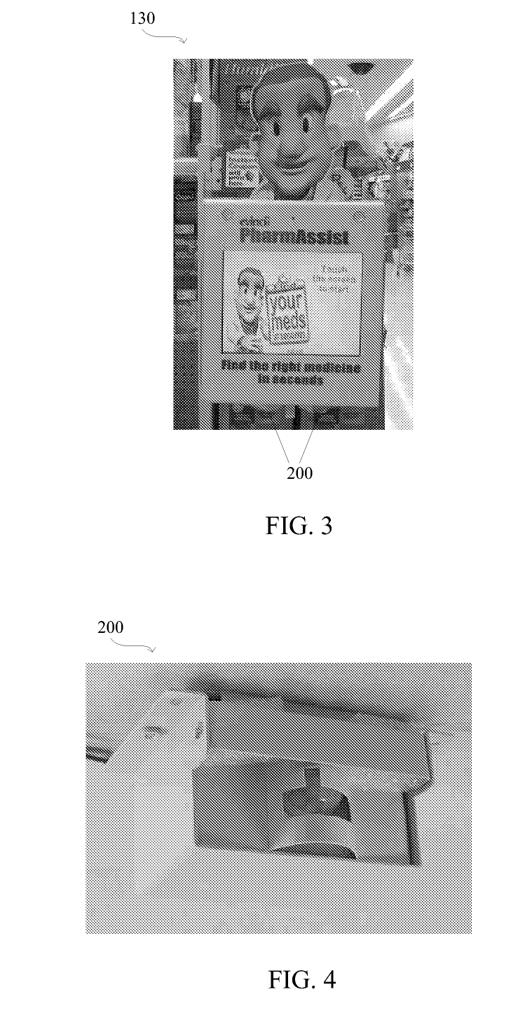

FIG. 3 is a diagram illustrating the kiosk 130 with a plurality of motion detectors 200. In an embodiment of the invention, the motion detectors 200 are located on a bottom side of the kiosk 130. In an embodiment, the motion detectors 200 can be located in or attached to a different portion of the kiosk 130. In another embodiment, the motion detectors 200 can be located a distance from the kiosk 130 and communicate sense data to the kiosk 130 for processing. In an embodiment, the kiosk 130 includes one or more motion detectors 200. The motion detectors 200 may sense motion using acoustical (e.g., ultrasound) and/or optical (e.g., infrared and/or laser) techniques.

FIG. 4 is a diagram illustrating a motion detector 200. The motion detector 200 includes a mask with a cutout thereon to enable configuration of the sensitivity, range and angle of motion detection or even the contour of the range. In an embodiment, the motion detector emits radiation and/or sound 90° to 360° horizontally and/or vertically while the mask blocks some of the emitted radiation and/or sound to cover only the area 140.

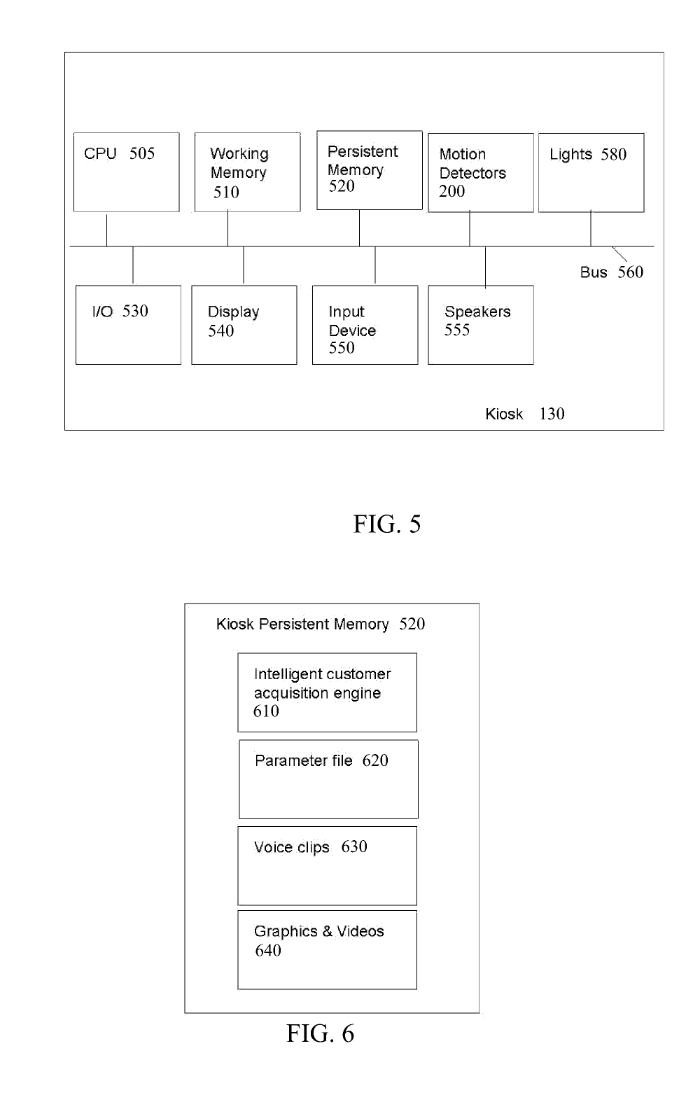

FIG. 5 is block diagram illustrating components of the kiosk 130 according to an embodiment of the invention. The kiosk 130 includes a processor (e.g., CPU) 505; working memory 510; persistent memory 520; motion detectors 200; lights 580; an input/output (I/O) interface 530; a display 540; an input device 550; speaker(s) 555; and lights 580, all communicatively coupled via a bus 560. The motion detectors 200, as mentioned above, detect motion of a customer in the area 140. The CPU 505 may include an INTEL XEON microprocessor, a Motorola POWERPC microprocessor, or any other processor capable to execute software stored in the persistent memory 520. The working memory 510 may include random access memory (RAM) or any other type of read/write memory devices or combination of memory devices. The persistent memory 520 may include a hard drive, read only memory (ROM) or any other type of memory device or combination of memory devices that can retain data after the kiosk 130 is shut off. In an embodiment, the interface 530 is communicatively coupled, via wired or wireless techniques, to a network, such as the Internet. The display 540 may include a flat panel display, cathode ray tube display, or any other display device. The input device 550, may include a keyboard, mouse, touch screen or other device for inputting data, or a combination of devices for inputting data. The speakers 555 emit sound in mono or stereo. The lights 580 may include light-emitting diodes (LEDs) or any device capable of emitting light in any color.

In an embodiment of the invention, the kiosk 130 may also include additional devices, such as network connections, additional memory, additional processors, LANs, input/output links for transferring information across a hardware channel, the internet or an intranet, etc. One skilled in the art will also recognize that the programs and data may be received by and stored in the kiosk 130 in alternative ways.

FIG. 6 is a block diagram illustrating the persistent memory 520 of the kiosk 130. The persistent memory 220 comprises an intelligent customer acquisition engine 610, a parameter file 620, voice clips 630, and computer graphics and videos 640. The intelligent customer acquisition engine 610 keeps a log/history of the motion detected (e.g., when or how long the motion-detected is “ON”). It compares each new signal (e.g., “ON”/“OFF” or “1”/“0”) from motion detectors 200 against the history of motions detected, in the context of the parameters customized for a particular kiosk and stores them in parameter file 620 during the current date and time, to intelligently determine whether a customer is (1) near the kiosk and (2) whether he/she just passed the kiosk or (3) he/she has been shopping near the kiosk for some time. Based on these input, the intelligent customer acquisition engine 610 will pick appropriate voice or sound clips from a pool of voice or sound clips 630 to play using speakers 555, pick appropriate computer graphics (e.g., video) 640 to display on kiosk display 540, and flash lights 580 to engage the customer. The parameter file 620 contains parameters that control the logic the intelligent customer acquisition engine uses and the actions it takes to engage customers. In an embodiment of the invention, the parameter file 620 contains the following parameters:
MotionRule: An integer that specifies which motion detection rule to use. Rules are stored in the intelligent customer acquisition engine 610. In an embodiment of the invention, a rule includes the following:

```
keep executing every 50 msec
begin
    Get value of VolumeLevel based on current time;
    Get value of AloneInterval based on current time;
    Get value of GreetingGap based on current time;
    Check motion detectors;
    if no motion then
    begin
          if (CurrentTime − LastMotionTime) > AloneInterval
then
            NextCustomerIsNew = true;
        exit;
    end
    LastMotionTime = CurrentTime;
    if (CurrentTime − LastGreetingTime) > GreetingGap then
    begin
        LastGreetingTime = CurerntTime;
        if NextCustomerIsNew
            Play initial voice greeting with VolumeLevel;
        else
          Play lingering voice message with VolumeLevel;
        NextCustomerIsNew = false;
    end
end
```

In another embodiment of the invention, a rule is similar to the above one except the engine will play lingering video after playing lingering voice message.
TimePeriods: Comma separated list of starting hours (0-23) of different time periods when different customer acquisition strategies can be used. For example, 9, 11, 21, 22 define 4 periods in a day. First period starts from 9:00 am and ends at 11:00 am. Second period starts at 11:00 am and ends at 9:00 pm. Third period starts at 9:00 pm and ends at 10:00 pm. The last period starts at 10:00 pm and ends at 9:00 am the following day. The customer acquisition strategies refer to different values of the parameters VolumeLevels, AloneIntervals, GreetingGaps (the knobs that tune the motion rules) which affect the customer acquisition strategies, i.e. the aggressiveness of acquiring customers. For example, TimePeriods=9, 11, 21, 22 and VolumeLevels=6, 7, 6, 5 mean between 9:00 am to 11:00 am, the engine will use volume level 6 to greet (medium aggressive). Between 11:00 am to 9:00 pm, the engine will use volume level 7 (more aggressive) because those are the peak hours for stores. Between 9:00 pm to 10:00 pm, the engine will use volume level 6 again. Between 10:00 pm to 9:00 am, the engine will use volume level 5 because stores are in general quieter at night.
VolumeLevels: Comma separated list of integers (0-10) specifying the volume level of voice greetings corresponding to each time period defined by TimePeriods.

AloneIntervals: Comma separated list of integers specifying the AloneInterval in seconds corresponding to each time period defined by TimePeriods. If the intelligent customer acquisition engine 610 does not detect any motion in AloneInterval seconds, it will assume that the previous customer left the area 140 already. It will assume that any subsequent motion detected is triggered by a new customer.
GreetingGaps: Comma separated list of GreetingGap corresponding to each time period defined by TimePeriods. Each GreetingGap is a list of integer separated by ‘|’. The first integer in GreetingGap list specifies the number of seconds between the first voice clip and the second voice clip for use with a lingering customer. The second integer specifies the number of seconds between playing the second and the third voice clips and so on. A sample value of GreetingGaps may look like: 30|45|45,20|30|45,30|45|45,90|90|90.
GreetingMuteResume: Number of minutes to re-activate voice greetings after a store staff de-activated voice greetings.
FasterFlashLightsPeriod: Number of seconds to flash the lights faster when greeting a customer.
DisableMotion: Integer/flag to enable/disable motion detectors. Sample values:
   0: Enable all motion detectors
   1: Disable motion detector 1
   2: Disable motion detector 2
   3: Disable motion detector 1 & 2
   . . .
MessageGroup: A capital character specifying the message group to be used to greet/acquire customers. Sample values: A, B, C, etc.
EsPercent: An integer (0-100) specifying the percent of time to play Spanish messages.

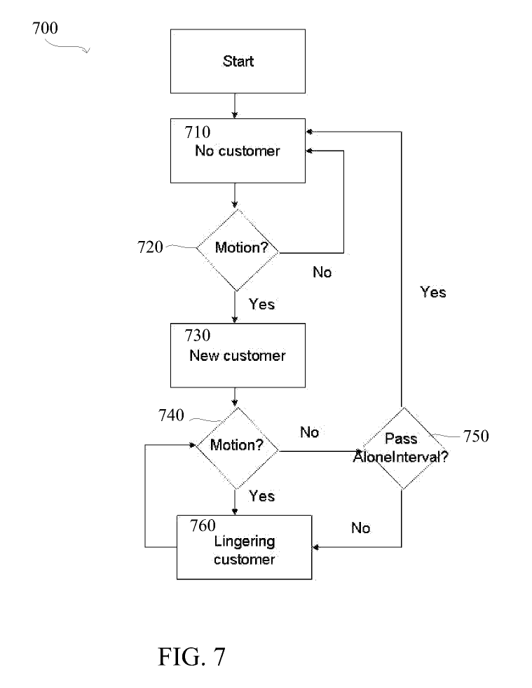

FIG. 7 is a flowchart illustrating a method 700 of selectively generating audio notices. The intelligent customer acquisition engine 610 first picks a rule to execute based on the parameter MotionRule. Then it enters the “No customer” state (710). The engine 610 periodically (e.g., every 250 msec) consults each motion detector to see if any motion is detected. It compares each new signal (e.g., “ON”/“OFF” or “1”/“0”) from motion detectors 570 against the history of motions detected, in the context of the parameters customized for a particular kiosk and stores them in parameter file 620 during the current date and time, to intelligently determine whether a customer is (1) near the kiosk and (2) whether he/she just passed the kiosk or (3) he/she has been shopping near the kiosk for some time. If no motion is detected, it remains in the “No customer” state (710). If the motion history has been “OFF” (720) for over X seconds (e.g., X=5), the engine 610 assumes that there is no one there and resets the kiosk 130 to “No customer” state (710). When a new “ON” signal is detected (720) after X seconds, the engine 610 assumes this is a “NEW Customer” (730). In an embodiment, during the “No customer” state (710), the kiosk 130 uses:
computer graphics displayed on screen,
video displayed on screen, and/or
flashing lights on the kiosk at randomized time to attract customers outside the range of motion detection. When entering “New customer” state (730), the kiosk 130 uses:
computer graphics displayed on screen,
video displayed on screen,
rapid flashing lights on the kiosk, and/or
voice greeting or sound clips played through speakers on kiosk to engage a customer approaching or that just passed by the kiosk 130. Since customers may be annoyed by repetitive voice messages, the intelligent customer acquisition engine 610 picks a voice message/sound clip from a portfolio of many clips, which can be specified by the parameter MessageGroup. Furthermore, the engine 610 can make use of the time motion is detected to alter the greeting, e.g. pre-affix “Good morning” to the voice message before 12:00 pm, pre-affix “Good afternoon” to the voice message after 12:00 pm but before 6:00 pm, and pre-affix “Good evening” to the voice message after 6:00 pm. After initial attempt to attract the customer, the intelligent customer acquisition engine 610 continues to probe (740) each motion detector periodically for any motion nearby. If no motion is detected for longer (750) than the period specified by the parameter AloneInterval (X), the engine 610 assumes the customer left the area already and it returns to the “No customer” state (710). Otherwise (i.e., if it continues to receive motion-detected “ON” signal from at least one of the motion detectors), it enters the “Lingering customer” state (760), assuming the same customer is still shopping nearby. While in the “Lingering customer” state, it uses:
computer graphics displayed on screen,
video displayed on screen,
rapid flashing lights on the kiosk, and/or
voice greeting or sound clips played through speakers on kiosk at intervals specified by the parameter GreetingGaps
   to engage the customer. Voice messages and sound clips are picked from the portfolio specified by the parameter MessageGroup to avoid repetitive messages. The intelligent customer acquisition engine 610 repeats this method 700 until a customer uses the kiosk 130 by touching its touch screen. In this “Lingering Customer” state (760), it is usually less aggressive and less annoying to the near-by customer.

The aggressiveness of this customer acquisition method 700 can be controlled by multiple parameters. For example, raising the volume level of the speakers is more likely to get customers' attention. Reducing AloneInterval can make the intelligent customer acquisition engine 610 go back to “No customer” state (710) more often and play initial voice messages more frequently. Reducing GreetingGaps can make the engine 610 play “lingering customer” messages more frequently. Increasing FasterFlashLightsPeriod can increase the chance of catching customers' attention. TimePeriods allows one to define multiple time periods based on different traffic pattern in a store at different time of a day, and to tune the aggressiveness differently for different time periods. To improve the effectiveness of the voice messages in certain demographical areas, a percentage of the voice messages, specified by EsPerecent, are played in a different language, e.g. Spanish. In an embodiment of this invention, the values of all the parameters are customized based on the characteristics of a store, e.g. size of store, store hours, traffic pattern, demographics, etc. In another embodiment of this invention, the values of the parameters are automatically adjusted by the engine based on historical traffic volume and pattern (e.g. volume and pattern of motions detected) and historical volume and pattern of language picked by customers. The higher the store traffic, the more aggressive the engine will be to minimize the chance of missing new approaching/passed by customers.

To allow store staff to work nearby the kiosk (e.g. replenishing products on shelves near the kiosk) without being distracted by the kiosk, the intelligent customer acquisition engine 610 provides a way (only known to the store) to mute the kiosk temporarily. The time to un-mute the kiosk automatically is controlled by the parameter GreetingMuteResume.

To avoid detecting undesirable motion, e.g. when one of the motion detectors is pointing to a checkout stand, each motion detector can be individually disabled by the parameter DisableMotion. Further, the, the sensitivity, range and angle of motion detection or even the contour of the range can be configured or adjusted by applying a customized mask on the motion detector 200.

The foregoing description of the illustrated embodiments of the present invention is by way of example only, and other variations and modifications of the above-described embodiments and methods are possible in light of the foregoing teaching. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
sensing a customer adjacent to a kiosk using a motion sensor;
determining if the customer has lingered by the kiosk for a period of time; and
emitting a first aural greeting from the kiosk if it is determined that the customer has not lingered.

2. The method of claim 1, further comprising:
displaying graphics if it is determined that the customer has not lingered.

3. The method of claim 1, further comprising:
flashing kiosk lights if it is determined that the customer has not lingered.

4. The method of claim 1, wherein the period of time is based on the time of day.

5. The method of claim 1, wherein the period of time is based on historical store traffic.

6. The method of claim 1, wherein the aural greeting varies based on the time of day.

7. The method of claim 1, further comprising continuing to emit an aural greeting if it is determined that a customer is lingering.

8. The method of claim 7, further wherein subsequent aural greetings emitted are different from earlier emitted aural greetings.

9. The method of claim 1, wherein the language of the aural greeting is based on historical language selection of kiosk users.

10. The method of claim 1, wherein the sensing is restricted to a specified area via placement of a mask over the sensor.

11. A kiosk, comprising:
a motion sensor for sensing a customer adjacent to the kiosk;
electronics, communicatively coupled to the sensor, for determining if the customer has lingered by the kiosk for a period of time; and
a speaker, communicatively coupled to the electronics, for emitting a first aural greeting if it is determined that the customer has not lingered.

12. The kiosk of claim 11, further comprising:
a display, communicatively coupled to the electronics, for displaying graphics if it is determined that the customer has not lingered.

13. The kiosk of claim 11, further comprising:
lights, communicatively coupled to the electronics, for flashing if it is determined that the customer has not lingered.

14. The kiosk of claim 11, wherein the period of time is based on the time of day.

15. The kiosk of claim 11, wherein the period of time is based on historical store traffic.

16. The kiosk of claim 11, wherein the aural greeting varies based on the time of day.

17. The kiosk of claim 11, further comprising continuing to emit an aural greeting if it is determined that a customer is lingering.

18. The kiosk of claim 17, further wherein subsequent aural greetings emitted are different from earlier emitted aural greetings.

19. The kiosk of claim 11, wherein the language of the aural greeting is based on historical language selection of kiosk users.

20. The kiosk of claim 11, wherein the sensing is restricted to a specified area via placement of a mask over the sensor.

21. A system, comprising:
means for sensing a customer adjacent to a kiosk using a motion sensor;
means for determining if the customer has lingered by the kiosk for a period of time; and
means for emitting a first aural greeting from the kiosk if it is determined that the customer has not lingered.
